(19) United States
(12) Patent Application Publication
(10) Pub. No.: US 2015/0207705 A1
(43) Pub. Date: Jul. 23, 2015

(54) METHOD FOR FILE ACTIVITY MONITORING

(71) Applicant: Filetrek Inc., Ottawa (CA)

(72) Inventor: Ben Piercey, Richmond (CA)

(21) Appl. No.: 14/579,469

(22) Filed: Dec. 22, 2014

Related U.S. Application Data
(60) Provisional application No. 61/920,007, filed on Dec. 23, 2013.

(51) Int. Cl. H04L 12/26

(52) U.S. Cl. CPC H04L 43/06

(57) ABSTRACT

A method is disclosed for forming a human intelligible log file. A server is provided in communication with a network. A first computer system is also provided in communication with the network. A first user authorizes themselves to the server from the first computer via the network. Data is accessed by a first application in execution on the first computer system, the data accessed within the first session. An entry is stored within a log file on the server as a single log entry therein and other than uniquely associated with the application an indication of the first user, the first file, and a file operation.

### FIELD

The invention relates generally to tracking file activity, and more particularly to a method for creating a log file comprising file access and change history.

### BACKGROUND

Security of documentation is of great importance to most large corporations. Protecting sensitive, confidential or company specific information enables entities to operate without interference from the misuse of information. Companies expend many resources maintaining and improving corporate data networks in an effort to prevent external sources, such as hackers and viruses, from gaining access to, or destroying, important data. For example, to enable employees access to company data while working from home, Virtual Private Networks are configured to allow access to company documentation by authorized personnel located outside of the company intranet. Campus-to-campus data security, such as tunneling, provides secure data paths for the exchange of company information between remote sites. There exists many other types of security protocols and methods for preventing the access of internal documentation by an external source. However, if the source for leaking documentation comes within the company, for example, by an employee, these security methods are ineffective.

One method of security is forensic security. In forensic security, an organization stores all the information they need to analyze and diagnose an issue that has happened. A common form of forensic security is activity logging. In activity logging, a log file is formed logging system activity. During forensic analysis log files from all the interrelated systems are loaded and analyzed to figure out a series of events. Unfortunately, when some log files are missing, it is much harder to be certain of the events.

It would be advantageous to overcome some of the disadvantages of the prior art.

### BRIEF SUMMARY

In at least one embodiment, the present invention provides a method having the steps of providing a server in communication with a network, providing a first computer system in communication with the server via the network, providing a first user authorized on the first computer and logged in to a first session thereon, providing a first application in execution on the first computer, the first application for accessing data, accessing data with the first application, the data accessed within the first session, and storing within a log file on the server as a single log entry therein and other than uniquely associated with the application an indication of the first user, a first file, and a file operation.

In another embodiment, the present invention provides a method having the steps of providing a server in communication with a network, providing a first computer system in communication with the server via the network, providing a first user authorized on the first computer and logged in to a first session thereon, within the first session providing data to an exit port of the network, the exit port for transmitting the data beyond the network, and storing within a log file on the server as a single log entry therein and other than uniquely associated with the application an indication of the first user, an indication of the data, and an indication that the data was provided at an exit port of the network.

### BRIEF DESCRIPTION OF THE DRAWINGS

The features and advantages of the invention will become more apparent from the following detailed description of the preferred embodiment(s) with reference to the attached figures, wherein:

FIG. 1 shows a simplified block diagram of an authorized user logging into a network and opening a file;

FIG. 2 shows a simplified block diagram of an authorized user logging into a network and opening and scrolling through text of a file;

FIG. 3 shows a simplified block diagram of an authorized user logging into a network and opening and issuing a ‘Print Screen’ operating system command to print the screen to a printer;

FIG. 4 shows a simplified block diagram of an authorized user logging into a network and renaming a data file in a software application;

FIG. 5 shows a simplified block diagram of an authorized user logging into a network and renaming a data file using an operating system command;

FIG. 6 shows a simplified block diagram of an authorized user logging into a network and copying and pasting a file;

FIG. 7 shows a simplified block diagram of an authorized user logging into a network and electronically transferring a file;

FIG. 8 shows a simplified block diagram of an authorized user logging into a network and copying and pasting text from one document to another;

FIG. 9 shows an example of a log file according to an embodiment;

FIG. 10 shows a simplified block diagram of the file association stored in a log file for various associated data files; and

FIG. 11 shows a simplified block diagram of a system for generating meaningful log files according to an embodiment of the invention;

FIG. 12A shows an example of a user log file according to at least one embodiment of the present invention; and

FIG. 12B shows an example of a user log file according to another embodiment of the present invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

File access is achieved by utilizing operating system (OS) commands or commands performed within a software application. Operating systems, such as Microsoft Windows® or MAC OS®, provide a user with generic commands that can be performed on most data files. Some specific and non-limiting OS commands include copy and pasting a file from one directory to another, renaming of a file, and printing the graphics/text on the screen. A specific software application is not required to perform these commands as they are “built” into the computer operating system. Alternatively, files are also accessed from within a software application that is specific for the type of data file. For example, Microsoft Word® is used to access .txt or .doc files, whereas Acrobat Reader® is used to access .pdf files. While open in a specific software application, a file is accessible and often manipulated, the data is changed within the file. Other specific and non-limiting examples of commands executable within a software application include scrolling of data, printing of data, renaming the file and saving the file. Most commands executed on data files via an OS or a software application have zero traceability in terms of recording which user executed the command, the file affected, when the command was executed, or the data that is passed from one file to another.

### Opening Files

A system of maintaining visibility of file access and file activity according to an embodiment is shown in a simplified block diagram in FIG. 1. An authorized user 101 using computer 102 logs into a company network 103 via a communications link 104. Servers 105 and 106 are also in communication with the company's network 103 via communication links 107 and 108 respectively. Authorized user 101 accesses data file 109 stored on server 105 by opening data file 109 in a software application. For example, data file 109 is a Word® document and authorized user 101 opens data file 109 in a Word® application. Upon opening data file 109, a record of user 101 opening data file 109 is logged into log file 110 stored on server 106. For example, the name of authorized user 101, the name of data file 109, data file 109 location (server name and directory), time of day, and computer's 102 IP address is recorded in log file 110. Alternatively, the log file 110 is stored on server 105. Optionally, other information such as the time and date data file 109 is closed, the MAC address and the physical location of computer 102 within the company premises is also recorded in log file 110.

Optionally, authorized user 101 is remotely logged into company network 103 via a secured communications network via the Internet. Optionally, the internet service provider (ISP) used by the user is also recorded in log file 110. Optionally, authorized user 101 is remotely logged into company network 103 from a remote company campus via a secured communications channel via the Internet.

### Scrolling through Files

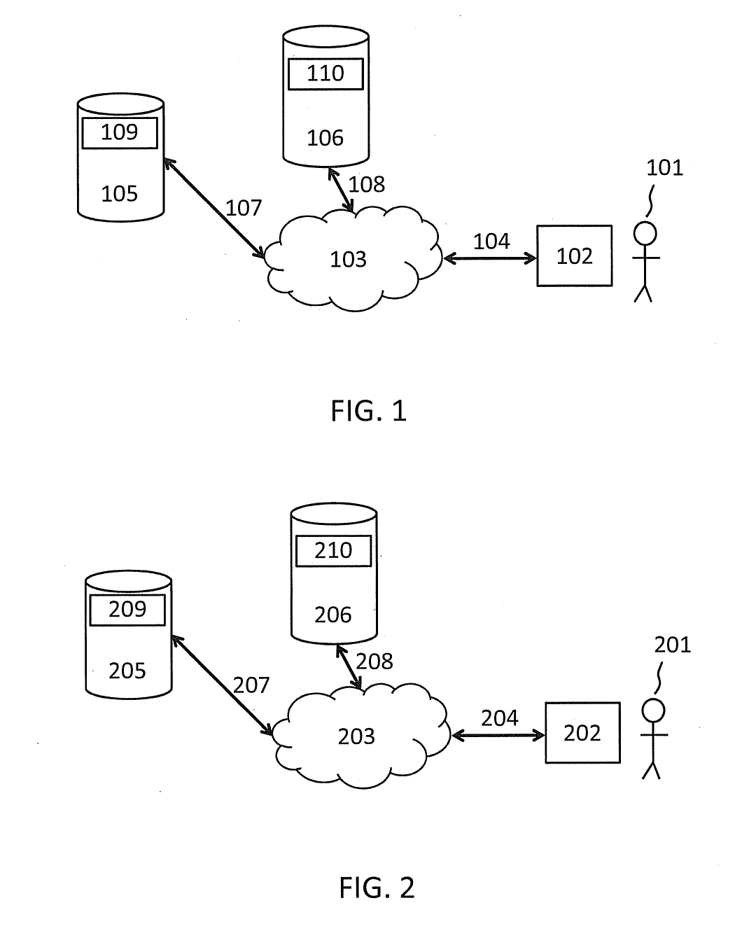

A system of maintaining visibility of file access and file activity according to an embodiment is shown in a simplified block diagram in FIG. 2. An authorized user 201 using computer 202 logs into a company network 203 via a communications link 204. Servers 205 and 206 are also in communication with the company's network 203 via communication links 207 and 208 respectively. Authorized user 201 accesses data file 209 stored on server 205 by opening data file 209 in a software application. For example, data file 209 is a Word® document and authorized user 201 opens data file 209 in a Word® application. Upon opening data file 209, a record of user 201 opening data file 209 is logged into log file 210 stored on server 206. Next, user 201 scrolls through some of the text in the Word® document. An indication of the scrolling activity and an indication of the text that appears on the screen during the scrolling activity is also recorded in log file 210. For example, the name of authorized user 201, the name of data file 209, data file 209 location (server name and directory), time of day, computer's 202 IP address, an indication of the scrolling activity, the lines numbers that were visible on the screen and the time and date that data file 209 is closed is recorded in log file 210. Alternatively, the log file 210 is stored on server 205. Optionally, other information such as the MAC address and the physical location of computer 202 within the company premises is also recorded in log file 210.

Optionally, authorized user 201 is remotely logged into company network 203 via a secured communications network via the Internet. Optionally, the ISP used by the user is also recorded in log file 210. Optionally, authorized user 201 is remotely logged into company network 203 from a remote company campus via a secured communications channel via the Internet.

### Print Screen to Printer

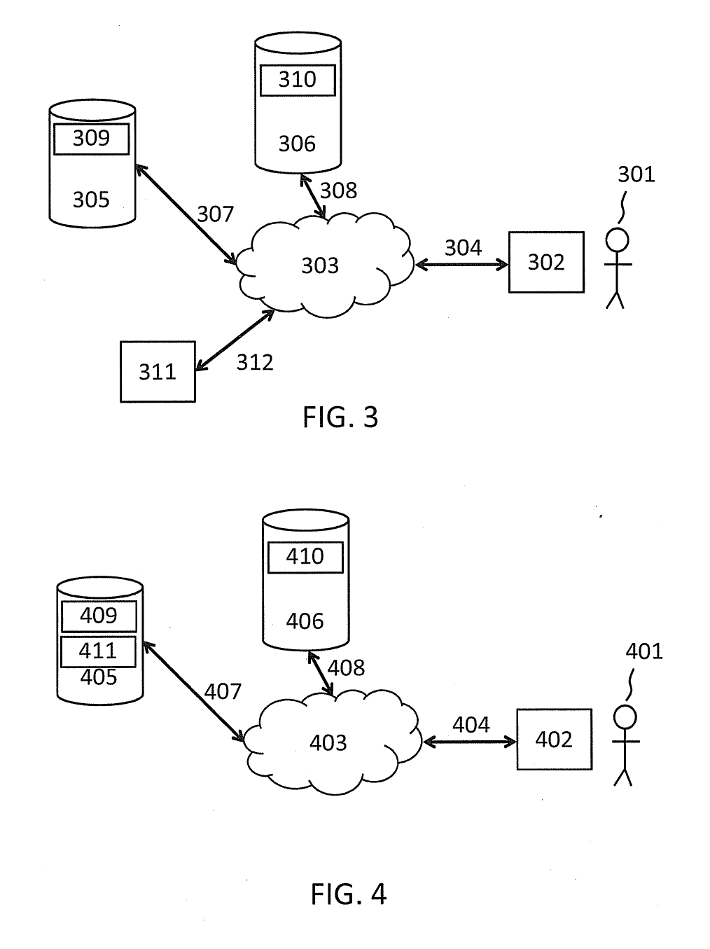

Another system of maintaining visibility of file access and file activity according to an embodiment is shown in a block simplified diagram in FIG. 3. An authorized user 301 using computer 302 logs into a company network 303 via a communications link 304. Servers 305 and 306 and printer 311 are also in communication with the company's network 303 via communication links 307, 308 and 312 respectively. Authorized user 301 accesses data file 309 stored on server 305 by opening data file 309 in a software application. For example, data file 309 is a Word® document and authorized user 301 opens data file 309 in a Word® application. Upon opening data file 309, a record of user 301 opening data file 309 is logged into log file 310 stored on server 306. Alternatively, the log file 310 is stored on server 305. Next, user 301 initiates an operating system command, ‘Print Screen.’ An indication of the printer 311 from which the Word® document prints is also recorded in log file 310. For example, the name of authorized user 301, the name of data file 309, data file 309 location (server name and directory), time of day data file 309 is opened, computer's 302 IP address, an indication of the ‘Print Screen’ activity, the lines numbers that were visible on the screen at the time ‘Print Screen’ activity occurred, the time the document was printed, the name/IP address of the printer (i.e. printer 311) and the time and date that data file 309 is closed is recorded in log file 310. Optionally, other information such as the MAC address, the physical location of computer 302, and the physical location of the printer within the company premises is also recorded in log file 310.

Optionally, authorized user 301 is remotely logged into company network 303 via a secured communications network via the Internet. Optionally, the ISP used by the user is also recorded in log file 310. Optionally, authorized user 301 is remotely logged into company network 303 from a remote company campus via a secured communications channel via the Internet.

### Print Screen to New File

Alternatively, the authorized user 301 initiates the operating system command ‘Print Screen’ to a new file. The name of the new file and the location (server name and directory) of the new file is recorded in the log file 310. There is now a traceable record of the association of the new file to original data file 309.

### Modifies the Data File and Saved Under Same Name

Shown in FIG. 4 is a simplified block diagram of a system maintaining visibility of file access and file activity according to an embodiment. An authorized user 401 using computer 402 logs into a company network 403 via a communications link 404. Servers 405 and 406 are also in communication with the company's network 403 via communication links 407 and 408 respectively. Authorized user 401 accesses data file 409 stored on server 405 by opening data file 409 in a software application. For example, data file 409 is a Word® document and authorized user 401 opens data file 409 in a Word® application. Upon opening data file 409, a record of authorized user 401 opening data file 409 is logged into log file 410 stored on server 406. For example, the name of authorized user 401, the name of data file 409, data file 409 location (server name and directory), time of day, and computer's 402 IP address is recorded in log file 410. Alternatively, the log file 410 is stored on server 405. Next, the authorized user 401 modifies the data file 409 and saves the modified version under the same name as the original data file 409 name. An indication that data file 409 has been modified and the time it was modified is recorded in log file 410. Optionally, other information such as the time and date file 409 is closed, the MAC address and the physical location of computer 402 within the company premises is also recorded in log file 410.

Optionally, authorized user 401 is remotely logged into company network 403 via a secured communications network via the Internet. Optionally, the ISP used by the user is also recorded in log file 410. Optionally, authorized user 401 is remotely logged into company network 403 from a remote company campus via a secured communications channel via the Internet.

### Modifies the Data File and Saved Under New Name

Alternatively, data file 409 is modified and the modified version of data file 409 is saved under a new name—data file 411—and stored on server 405. An indication of the modification made to data file 409 and name and location (directory and server) of the new file data file 411 is recorded in log file 410. Now there exists a traceable record of the association of the original data file 409 to the new file 411. Optionally, the location of the new data file 411 is stored on an external drive. Specific and non-limiting examples are a USB drive, a CD/DVD, an external hard drive and a portable media device such as an MP3 player.

### Renames Data File using Operating System Command

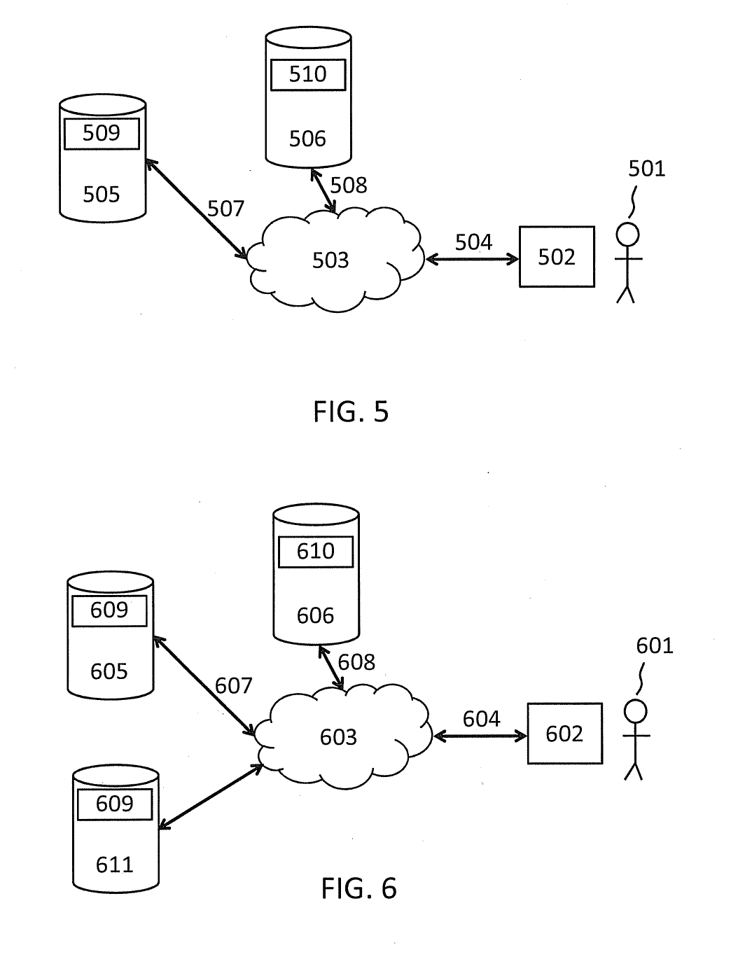

Shown in FIG. 5 is a block simplified diagram of maintaining visibility of file access and file activity according to an embodiment. An authorized user 501 using computer 502 logs into a company network 503 via a communications link 504. Servers 505 and 506 are also in communication with the company's network 503 via communication links 507 and 508 respectively. Authorized user 501 accesses data file 509 stored on server 505 by initiating a renaming operating system command to rename data file 509. For example, authorized user 501 renames data file 509 from ‘Summary’ to ‘Executive Summary’ by selecting the data file 509 and choosing from the operating system menu command, ‘rename’. An indication of authorized user 501 renaming data file 509 is recorded into log file 510 stored on server 506. For example, the name of authorized user 501, the original name of data file 509 (‘Summary’), the new name of data file 509 (‘Executive Summary’), data file 509 location (server name and directory), time of day the renaming activity occurred, and computer's 502 IP address is recorded in log file 510. Alternatively, the log file 510 is stored on server 505. Optionally, other information such as the MAC address and the physical location of computer 502 within the company premises is also recorded in log file 510. There is now a traceable record of the association of the new file ‘Executive Summary’ to original file ‘Summary.’

Optionally, authorized user 501 is remotely logged into company network 503 via a secured communications network via the Internet. Optionally, the ISP used by the user is also recorded in log file 510. Optionally, authorized user 501 is remotely logged into company network 503 from a remote company campus via a secured communications channel via the Internet.

### Copying and Pasting Files to Another Directory

Now referring to FIG. 6 shown is a block simplified diagram of a system maintaining visibility of file access and file activity according to an embodiment. An authorized user 601 using computer 602 logs into a company network 603 via a communications link 604. Servers 605 and 606 are also in communication with the company's network 603 via communication links 607 and 608 respectively. Authorized user 601 accesses data file 609 stored on server 605 by initiating a ‘Copy and Paste’ operating system command to copy data file 609 and paste it to another location. For example, authorized user 601 copies data file 609 by selecting the data file 609 and choosing from the operating system menu ‘Copy’. Next the user selects from the operating system menu ‘Paste’ and pastes a copy of data file 609 to a different location than the original data file 609, such as server 611 in communication with network 603 via link 612. An indication of authorized user 601 copying data file 609 and pasting a copy of data file 609 is recorded into log file 610 stored on server 606. For example, the name of authorized user 601, original data file 609 location (server name and directory), the location (server name and directory) of the copy of data file 609, time of day the copying and pasting activities occurred, and computer's 602 IP address is recorded in log file 610. Alternatively, the log file 610 is stored on server 605. Optionally, other information such as the MAC address and the physical location of computer 602 within the company premises is also recorded in log file 610. Optionally, authorized user 601 is remotely logged into company network 603 via a secured communications network via the Internet. Optionally, the ISP used by the user is also recorded in log file 610. Optionally, authorized user 601 is remotely logged into company network 603 from a remote company campus via a secured communications channel via the Internet. There is now a traceable record of the association of the copied file on server 611 to original data file 609 on server 605.

Optionally, authorized user 601 also renames the copy of data file 609. For example, authorized user 601 renames the copy of data file 609 stored on server 611 ‘Summary’ to ‘Executive Summary’. There is now a traceable record of the association of the new file ‘Executive Summary’ on server 611 to original data file ‘Summary’ on server 605.

Optionally, the location of the copy of the data file 609 is stored on an external drive. Specific and non-limiting examples are a USB drive, a CD/DVD, an external hard drive and a portable media device such as an MP3 player.

### Electronic Transferring of Files—i.e. Emailing & Ftping Files

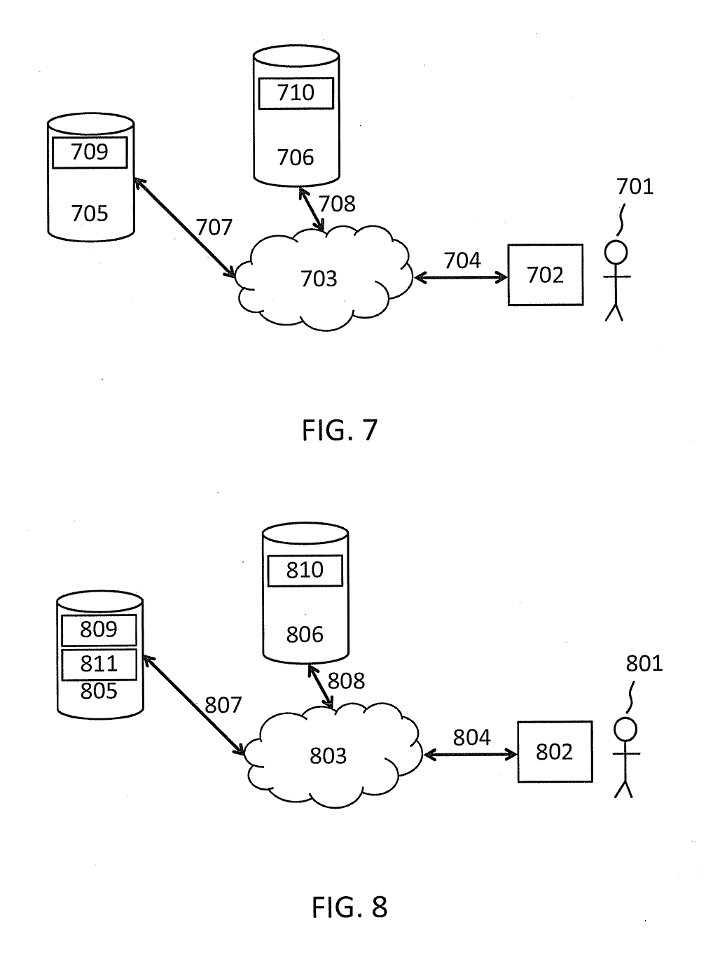

Shown in FIG. 7 is a simplified block diagram of maintaining visibility of file access and file activity according to an embodiment. An authorized user 701 using computer 702 logs into a company network 703 via a communications link 704. Servers 705 and 706 are also in communication with the company's network 703 via communication links 707 and 708 respectively. Authorized user 701 accesses data file 709 stored on server 705 by initiating an electronic data transfer command to transfer data file 709 to another location. For example, authorized user 701 selects data file 709 and attaches data file 709 to an email and emails data file to a recipient. An indication of authorized user 701 emailing data file 709 is recorded into log file 710 stored on server 706. For example, the name of authorized user 701, original data file 709 location (server name and directory), the sender email user account name, the recipient's name, time of day the emailing activity occurred, and computer's 702 IP address is recorded in log file 710. Alternatively, the log file 710 is stored on server 705. Optionally, other information such as the MAC address and the physical location of computer 702 within the company premises is also recorded in log file 710. Alternatively, authorized user 701 transfers the data file 709 using ‘file-transfer-protocol.’ Optionally, an indication of the recipient IP address is also recorded in log file 710.

Optionally, authorized user 701 is remotely logged into company network 703 via a secured communications network via the Internet. Optionally, the ISP used by the user is also recorded in log file 710. Optionally, authorized user 701 is remotely logged into company network 703 from a remote company campus via a secured communications channel via the Internet.

### Copying and Pasting Within the Software Application

Shown in FIG. 8 is a simplified block diagram of a system maintaining visibility of file access and file activity according to an embodiment. An authorized user 801 using computer 802 logs into a company network 803 via a communications link 804. Servers 805 and 806 are also in communication with the company's network 803 via communication links 807 and 808 respectively. Authorized user 801 accesses data file 809 stored on server 805 by opening data file 809 in a software application. For example, data file 809 is a Word® document and authorized user 801 opens data file 809 in a Word® application. Next, authorized user 801 copies a portion of the text from data file 809 and pastes the copied portion of text to another Word® document, data file 811 stored on server 805. An indication of the copying and pasting activities are recorded in log file 810. For example, the name of authorized user 801, the name of data file 809, the data file 809 location (server name and directory), time of day of copying and pasting activities, computer's 802 IP address, an indication of the text copied, the name and location (server name and directory) of data file 811, and the time and date that data file 809 is closed is recorded in log file 810. Alternatively, the log file 810 is stored on server 805. Optionally, other information such as the MAC address and the physical location of computer 802 within the company premises is also recorded in log file 810. There is now a traceable record of the association of the edited data file 811 to original data file 809 and an indication of the text that was copied and pasted.

Optionally, authorized user 801 is remotely logged into company network 203 via a secured communications network via the Internet. Optionally, the ISP used by the user is also recorded in log file 810. Optionally, authorized user 801 is remotely logged into company network 803 from a remote company campus via a secured communications channel via the Internet.

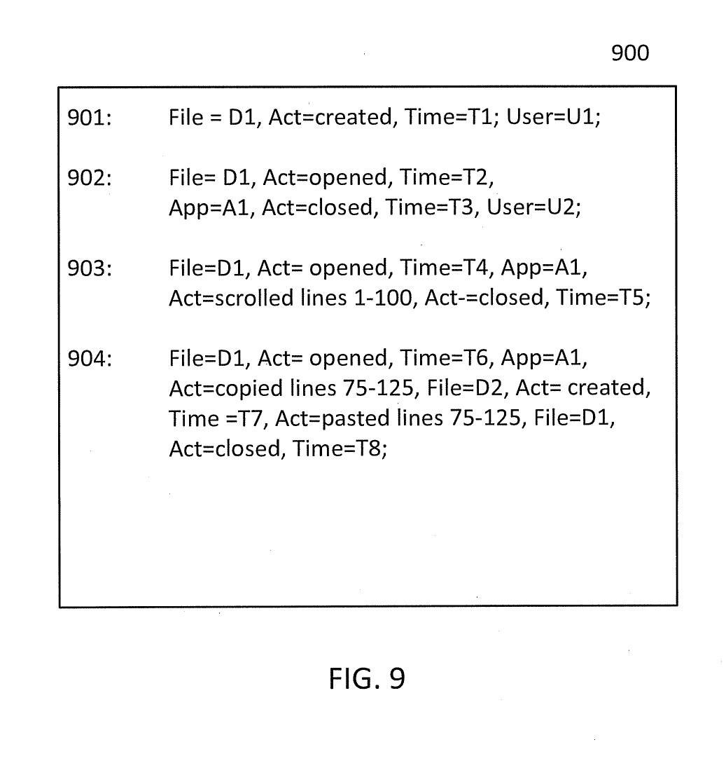

Now referring to FIG. 9, shown is a specific non-limiting example of a log file according to an embodiment. Data file history/activity for data files, including origin of data, user performing activity, and time and date of activity is recorded in log file 900. For example, at 901 data file D1 is created by user U1 at time T1. At 902, user U2 opens data file D1 at time T2 in application A1 and closes data file 909 at time T3. At 903, user U3 opens data file D1 in application A1, at time T4, scrolls through the first 100 hundred lines of text, and closes data file D1 at time T5. Next at 904, user U4 opens data file D1 in application A1 at time T6, copies lines 75-125, creates a new file D2 at time T7, pastes lines 75-125 from data file D1 into data file D2 and closes data file D1 at time T8. Users U1-U4, are authorized users which are logged into and identified by a network. Optionally, IP addresses of computers are resolved to identify the workstation the users are using to access the network data files.

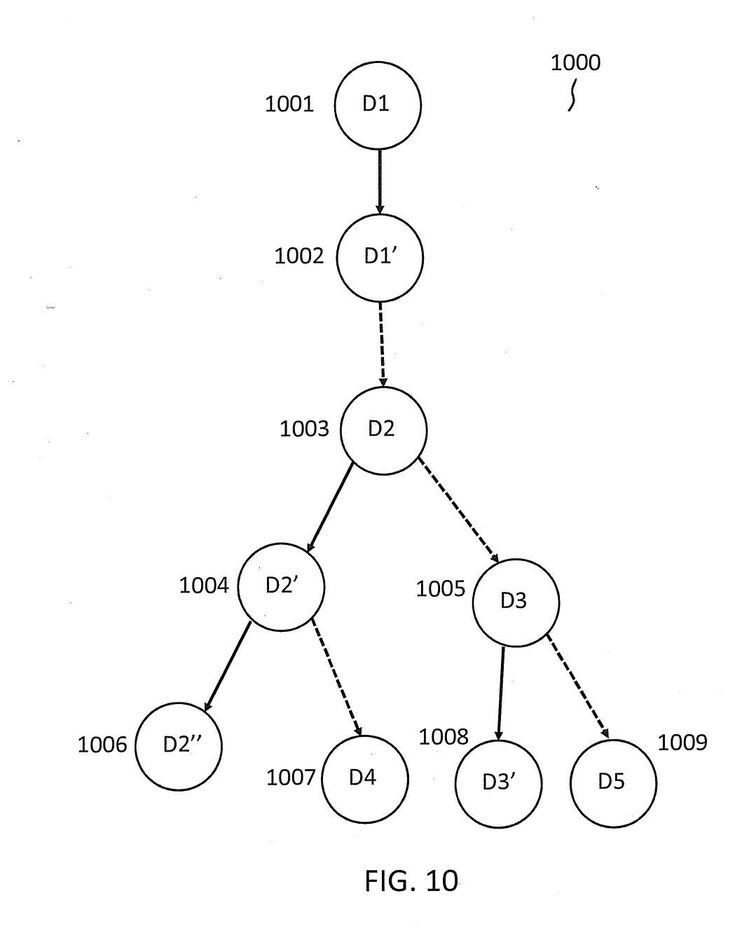

Shown in FIG. 10 is a simplified block diagram 1000 of the file association stored in a log file for various associated data files. Data file D1 is created at 1001. By use of operating system ‘Copy and Paste’ commands data file D1 is copied and pasted into a directory and named D1′ at 1002. Within a software application a portion of the data from D1′ is copied and pasted into file D2 at 1003. By use of operating system ‘Copy and Paste’ commands data file D2 is copied and pasted into a directory and named D2′ at 1004. Within a software application a portion of the data from D2 is copied and pasted into file D3 at 1005. By use of operating system ‘Copy and Paste’ commands data file D2′ is copied and pasted into a directory and named D2″ at 1006. Within a software application a portion of the data from D2′ is copied and pasted into file D4 at 1007. By use of operating system ‘Copy and Paste’ commands data file D3 is copied and pasted into a directory and named D3′ at 1008. Within a software application a portion of the data from D3 is copied and pasted into file D5 at 1009. With use of log file 1000 it is possible to trace the association between files D1, D1′, D2, D2′, D2″, D3, D3′, D4 and D5. For example, some of data in all data files D1′, D2, D2′, D2″, D3, D3′, D4 and D5 is from data file D1.

### Human Readable Log Files

System log files are cryptic and provide sparse information regarding system activity. For example, a computer communicates with a server via a network. The server logs the communication based on the computer IP address. When a user logs into the server, the system logs in the log file the user ID having logged into the server. As file access requests are made to the server, the IP address of the requesting computer is logged along with the request. This is also the case for other request types. As is noted, each log entry contains the information relating to the event, but may be difficult or impossible to discern from reviewing the log file in isolation and without special tools. Reviewing such a log file and resolving the identity of the users and locations of the computers accessed is tedious and time consuming and often requires log files from the client computers and from the server, thus it does not easily lend itself to identifying manually any patterns that may indicate a security risk. A log file that contains complete user and computer information, and is easily readable by a human, would aid in identifying security risks to the network and potentially preventing security breaches before they occur. That said, that information is not necessarily available to the operation entering data into the log.

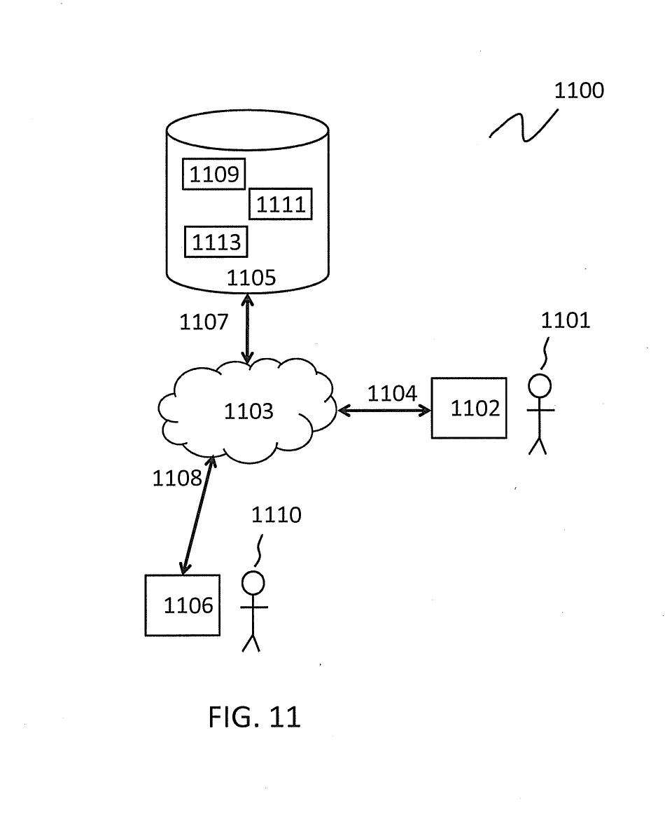

Now referring to FIG. 11, shown is a simplified block diagram of a system for generating human intelligible log files according to an embodiment of the invention. Prior art log files are cryptic and difficult to understand whereas a human intelligible log file comprises text that is easily understood by a human. Server 1105 monitors user and file activity within the company network 1100 maintaining information relating thereto. The server 1105 is in communication with intranet 1103 via communication link 1107. Computers 1102 and 1106 are also in communication with intranet 1103 via communication links 1104 and 1008, respectively. User 1101 logs into system 1100 using computer 1102. Computer 1102 transmits a message to server 1105 indicating a person using the user ID of user 1101 has logged into network 1100. System 1100 already knows that computer 1102 is coupled to the Intranet via a particular IP address and, as such, stores within a table data indicating that user 1101 is on computer 1102 and logged into server 1100. Lookup table 1109 is stored on server 1105 and comprises computer network 1100 details and optionally other status details, for example, the name of users, and an associated IP address of computer each user is using. Utilizing lookup table 1109, server 1105 creates a meaningful log entry in log file 1111 recording user activity on network 1100. For example, server 1105 stores the user ID, user name, time, date, computer 1102 IP address and computer 1102 identifier in log file 1111. As IP addresses are dynamic, when an IP address of a computer changes, the computer notifies the server and the server updates the table 1109. Alternatively, the server verifies the IP address table via the network at intervals. Next, user 1101 launches an application, for example Microsoft Word®. Data indicative of this application is stored either on the computer 1102 or on the server 1105. Word initiates opening file 1113 stored on server 1105. Computer 1102 transmits a message to server 1105 indicating that the Microsoft Word® application is the application initiating file 1113 access. Server 1105 creates another meaningful log entry in log file 1111 recording the user and file activity. Alternatively, the server 1105 already has an updated table indicating that the computer 1102 is executing Word and when the file access operation occurs, the server enters a similar log entry based on the file access request and the table information. Yet further alternatively, the server requests of computer 1102 further data for completing the log entry at the time of a file access request. Here, server 1105 stores the user ID, user name, time, date, an indication of the application (Microsoft Word®) accessing file 1113, computer 1102 IP address and computer 1102 identifier in log file 1111. Optionally, the lookup table comprises other information such as the department, telephone number, manager and office location of each user. Utilizing a lookup table comprising detailed user and network information aids in generating an easily understood log file. A system administrator has the information they need in a list or in a table within the log file without having to conduct a further search or analysis. Also, if computer 1102 is stolen, the log file 1111 is complete in and of itself. For example, if a user accesses a file that should not be accessed, the system administrator readily sees this. Optionally, the administrator has contact information of the user. The system administrator does not have to search for the phone number, manager name or office location of the user. Even when this is not the case, the mere simplicity of reviewing the log entries and seeing suspicious activities saves the administrator time in correlating log entries with human intelligible information.

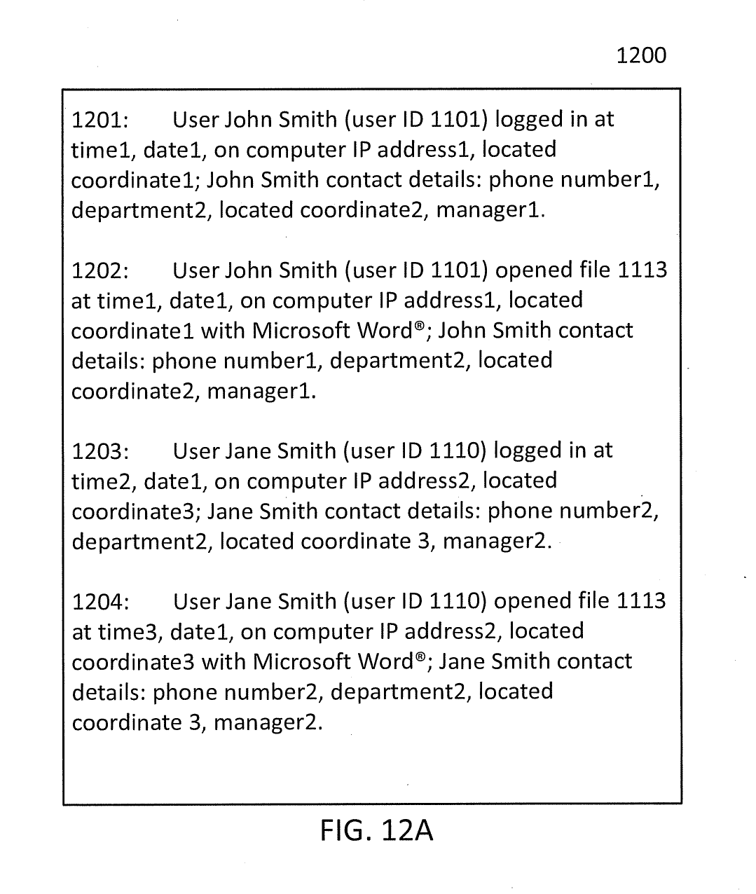

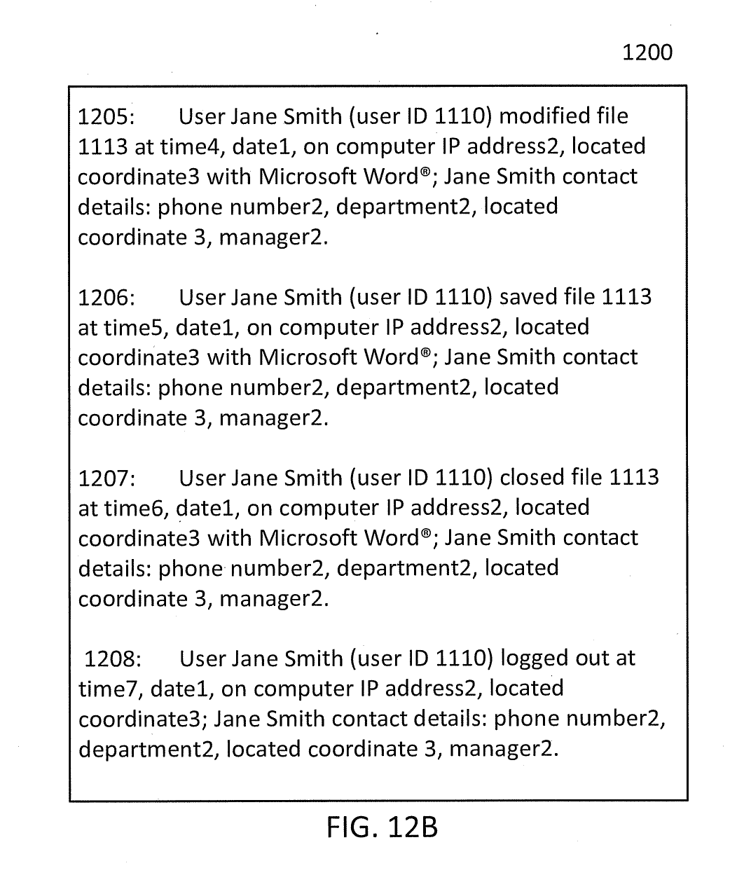

User 1110 logs into system 1100 using computer 1106. Computer 1106 transmits a message to server 1105 indicating a person using the user ID of user 1110 has logged onto the network 1100. Computer 1106 also transmits the IP address of computer 1106 to server 1105. Utilizing lookup table 1109, server 1105 creates a meaningful log entry in log file 1111 recording user activity on network 1100. For example, server 1105 stores the user ID, user name, time, date, computer 1106 IP address and computer 1106 physical location and/or identifier in log file 1111. Lookup table 1109 is updated to link the user and the IP address and the user name. Next, user 1110 launches an application, for example Microsoft Word®, and initiates opening file 1113 stored on server 1105. Computer 1106 transmits a message to server 1105 indicating that a Microsoft Word® application is the application initiating file 1113 access. Server 1105 creates another meaningful log entry in log file 1111 recording the user and file activity. For example, server 1105 stores the user ID, user name, time, date, an indication of the application Microsoft Word® accessing file 1113, computer 1106 IP address and computer 1106 identifier in log file 1111. Alternatively, server 1105 retrieves data from the lookup table indicating the application presently in execution on computer 1106 in order to log the application. Further alternatively, the application is not stored within the log as it is often not considered of consequence. It is likely sufficient in many instances to log the computer identifier as opposed to merely logging an IP address and user, the server and file, and the access details. User 1110 modifies file 1113 and closes the file. Computer 1106 transmits more messages to server 1105 regarding the user and file activity. Server 1105 creates another three meaningful log entries in log file 1111. Alternatively, the computer 1106 makes log entries that tie to a transaction and then uploads those entries to the server 1105 where they are reconciled with log entries and optionally the lookup table 1109 to result in a human intelligible log file. For example in the first log entry, server 1105 stores the user ID, user name, time, date, an indication of the application Microsoft Word® accessing file 1113, modifications to the file, computer 1106 IP address and computer 1106 computer identifier in log file 1111. In the next log entry, server 1105 stores the user ID, user name, time, date, an indication of the application Microsoft Word® closing file 1113, modifications to the file, computer 1106 IP address and computer 1106 identifier in log file 1111. In the third log entry, server 1105 stores the user ID, user name, time, date, an indication that user 1110 has logged out of the network 1100, computer 1106 IP address and computer 1106 identifier in log file 1111. Now referring to FIGS. 12A and 12B, shown is a log file according to an embodiment of the invention. Log file 1200 is the log file generated in system 1100. Log entries 1201-1208 record the user and file activity as described above in a easy to read manner.

In an embodiment, the log file that is human intelligible is formed based on the lookup table where the server cooperates with other systems to determine parameters thereof that are of use in forming the log file. The parameters are then stored in the lookup table. For example, the lookup table includes IP addresses and a relation to users such that a request from 192.168.1.1 for access to a file is loggable as a request from user X for the file. Similarly, a request for a particular sector is translatable into a request for a portion of a file as the server has access to its file allocation table. Thus, the log file is populated with human intelligible entries including information about who what where and when.

Similarly, when a user decides to transmit a file, the server logs the file access, and the mail server logs the user and the file being transmitted. Therefore, the file propagation flow is monitorable in a simple fashion through automated analysis, automated rule application, and manual review. Further, even less technical or non-technical people can often derive useful information form the log file.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

The embodiments of the invention for which an exclusive property or privilege is claimed are defined as follows.

What is claimed is:

1. A method comprising:
providing a server in communication with a network;
providing a first computer system in communication with the server via the network;
providing a first user authorized on the first computer and logged in to a first session thereon;
providing a first application in execution on the first computer, the first application for accessing data;
accessing data with the first application, the data accessed within the first session; and
storing within a log file on the server as a single log entry therein and other than uniquely associated with the application an indication of the first user, a first file, and a file operation.

2. A method as defined in claim 1 comprising:
storing a lookup table comprising a mapping of system level information to human intelligible information, the lookup table for use in forming the single log entry; and
resolving a system request at the server by looking up the data within the request in the lookup table to determine the indication of the first user.

3. A method as defined in claim 2 wherein within the lookup table is stored a correlation between the first system and the first user.

4. A method as defined in claim 2 wherein within the lookup table is stored a correlation between a system in communication with the server and an application in execution on the system.

5. A method as defined in claim 1 comprising:
requesting from the first computer data for resolving system level information to form human intelligible information; and
storing within the log file data received in response to the request.

6. A method according to any one of claims 1 to 5 wherein an indication of the first computer system is stored within the single log entry.

7. A method according to any one of claims 1 to 6 wherein the indication of the first user comprises a user name.

8. A method according to any one of claims 1 to 7 wherein the indication of the first user comprises a name of the first user.

9. A method according to any one of claims 1 to 8 wherein the log file includes a name of the user, a name of the file accessed, and log related data.

10. A method according to any one of claims 1 to 9 wherein the log file is in human intelligible form for being read and understood by a person other than familiar with log files.

11. A method according to any one of claims 1 to 9 wherein the log file is in human intelligible form for being read and understood by a person without further analysis based on data from another log file.

12. A method comprising:
providing a server in communication with a network;
providing a first computer system in communication with the server via the network;
providing a first user authorized on the first computer and logged in to a first session thereon;
within the first session providing data to an exit port of the network, the exit port for transmitting the data beyond the network; and
storing within a log file on the server as a single log entry therein and other than uniquely associated with the application an indication of the first user, an indication of the data, and an indication that the data was provided at an exit port of the network.

13. A method according to claim 12 wherein the log file is in human intelligible form for being read and understood by a person other than familiar with log files.

14. A method according to claim 12 wherein the log file is in human intelligible form for being read and understood by a person without further analysis based on data from another log file.

15. A method as defined in claim 12 comprising:
storing a lookup table comprising a mapping of system level information to human intelligible information, the lookup table for use in forming the single log entry; and
resolving a log entry comprising a system request at the server by looking up the data within the request in the lookup table to determine the indication of the first user.

16. A method as defined in claim 15 wherein within the lookup table is stored a correlation between the first computer system in communication with the server and the first user.

17. A log file comprising a plurality of log entries wherein each log entry comprises human intelligible information relating to an event, the log entry including a human understandable indication of a first user, a first action in response to a request, and an identifier of data for use in performing the first action.

18. A log file according to claim 17 wherein the human understandable indication of a first user comprises a name of the first user by which the first user is identified by people they know, wherein the first action comprises an English description of the first action and where in the identifier of data comprises a filename.

19. A log file according to claim 18 comprising:
timing information relating to each entry.

20. A log file according to claim 17 wherein the log file is for being human comprehensible absent any other data.
